(19) United States
(12) Patent Application Publication
(10) Pub. No.: US 2018/0187879 A1
(43) Pub. Date: Jul. 5, 2018

(54) MODULAR ILLUMINATION DEVICE FOR A MARINE ENVIRONMENT

(71) Applicant: Raymond Alan Seymour, West Palm Beach, FL (US)

(72) Inventor: Raymond Alan Seymour, West Palm Beach, FL (US)

(21) Appl. No.: 15/843,643

(22) Filed: Dec. 15, 2017

Related U.S. Application Data
(60) Provisional application No. 62/434,842, filed on Dec. 15, 2016.

(51) Int. Cl. F21V 31/00; F21S 2/00; F21V 29/76; F21V 3/00; F21V 5/00; F21V 5/04; F21V 29/89; F21V 17/12; F21V 17/10; B63B 45/06

(52) U.S. Cl. CPC F21V 31/005; F21S 2/005; F21V 29/76; F21V 3/00; F21V 5/007; F21Y 2115/10; F21V 29/89; F21V 5/045; F21V 17/12; F21V 17/101; B63B 45/06; F21V 5/04

(57) ABSTRACT

An illumination device is provided and adapted to be mounted to a transportation device, such as a boat, intended to be used in a high moisture environment and provide a sealed environment for lights contained therein. The illumination device can provide both spotlight and floodlight simultaneously using high efficiency lights such as LED's. The LEDs are positioned in relatively small windows that may be constructed to modify the distribution of the light as it is broadcast. In addition, the illumination device preferably includes an interchangeable face plate that may take any desirable perimeter shape to accent the features of the vessel or vehicle to which it is attached.

### RELATED APPLICATIONS

In accordance with 37 C.F.R 1.76, a claim of priority is included in an Application Data Sheet filed concurrently herewith. Accordingly, under 35 U.S.C. § 119(e), 120, 121, and/or 365(c), the present invention claims priority of U.S. Patent Application No. 62/434,842, entitled “MODULAR ILLUMINATION DEVICE FOR A MARINE ENVIRONMENT”, filed on Dec. 15, 2016. The contents of the above referenced application are herein incorporated by reference in its entirety.

### FIELD OF INVENTION

The present invention relates to an illumination device for use in an outdoor, high moisture environment. For example, the illumination device can be mounted on a boat. It can simultaneously provide different types of lighting.

### BACKGROUND OF THE INVENTION

Lights used for illumination are well known in the art, particularly those used on transportation devices such as cars, trucks, airplanes, motorcycles and watercraft such as boats and ships. Such lights can be considered to be used in severe environments facing operation issues related to extremes in temperature, shock and moisture. This often involves technical issues in designing and manufacturing an appropriate illumination device that will serve its intended function. Additionally, some lights are intended for long-range illumination, often called spotlights; and some are intended for short range illumination, often called floodlights. It is known in the art that the position of the source of light relative to a reflector can change an individual light from a spotlight to a floodlight and back. Fresnel lenses can also be used to collimate light.

In recent years, significant advances have been made in the field of light sources. This involves both the improvement in efficiency and life of the light source. Some of these advances include florescent lighting, such as compact fluorescent lights and light emitting diodes, or LED's. In order to provide the safety of redundancy, multiple light sources can be used in a single lighting device, but that makes having a single light source to function as both a flood and spot source of light difficult. This requires a mechanism to effect the adjustment, and also requires some intervention to effect the change.

There is thus a need for an improved lighting device to overcome the difficulties found in current illumination devices, and that can be provided in a single device.

### SUMMARY

An illumination device is provided and adapted to be mounted to a transportation device, such as a boat, intended to be used in a high moisture environment, and provide a sealed environment for lights contained therein. The illumination device can provide both spotlight and floodlight simultaneously using high efficiency lights such as LED's. The LEDs are positioned in relatively small windows that may be constructed to modify the distribution of the light as it is broadcast. In addition, the illumination device preferably includes an interchangeable face plate that may take any desirable perimeter shape to accent the features of the vehicle to which it is attached.

Accordingly, it is a primary objective of the instant invention to provide a modular illumination device that can be used reliably in severe environments.

It is a further objective of the instant invention to provide a modular illumination device that can provide both spotlight and floodlight in one device without intervention.

It is yet another objective of the instant invention to provide a modular illumination device having both spotlight and floodlight in a single unit.

It is still another objective of the present invention to provide a modular illumination device that includes a bezel and bezel frame that can take any perimeter shape for attachment to the remaining components of the light.

It is still another objective of the present invention to provide a modular illumination device that includes a bezel frame that can accommodate a plurality of independent lights.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front plan view of an illumination device;

FIG. 2 is a side elevation view of the illumination device shown in FIG. 1;

FIG. 3 is a rear plan view of the illumination device of FIG. 1;

FIG. 4 is an exploded plan view of the illumination device of FIG. 1 showing internal details thereof;

FIG. 5 is an exploded perspective view of the illumination device of FIG. 1; and

FIG. 6 is a fragmentary perspective view of the interior of the illumination device.

### DETAILED DESCRIPTION OF THE INVENTION

The reference 1 designates generally a modular illumination device having a plurality of light sources 3 enclosed in a housing, designated generally 5, and a source of electrical energy, designated generally 6.

The light sources 3 can be any suitable source of light, such as high efficiency lights, for example, light emitting diodes (LED's). The light sources are hereinafter referred to as lights 3 for convenience. In a preferred embodiment, the lights 3 can include both spot and flood type lights, designated generally 3A and 3B respectively. Any suitable number and arrangement of lights 3 can be utilized. In the illustrated structure, six sets of three lights 3 are provided and are arranged in generally parallel rows and columns. Preferably, the sets of lights 3 are each positioned behind a respective transparent bezel or window 7. As shown, a second window 8 is provided in overlying relation to the windows 7, and is suitably attached to a front mounting plate 10 portion of the housing 5. A window 7 or 8 can be colored if desired.

The windows 7 can be configured to achieve both spot and flood capability. For floodlight from the lights 3B, the windows 7 overlying them can be generally planar with opposing surfaces. For spotlight from the lights 3A, the windows 7 overlying them can be configured to collimate the emitted light. This can be done using any type of lens 16, including a Fresnel type lens configuration on a surface of the window 7. The lenses 16 can use a circular array or parallel array of surface contours 9, depending on how the emitted light is to be focused.

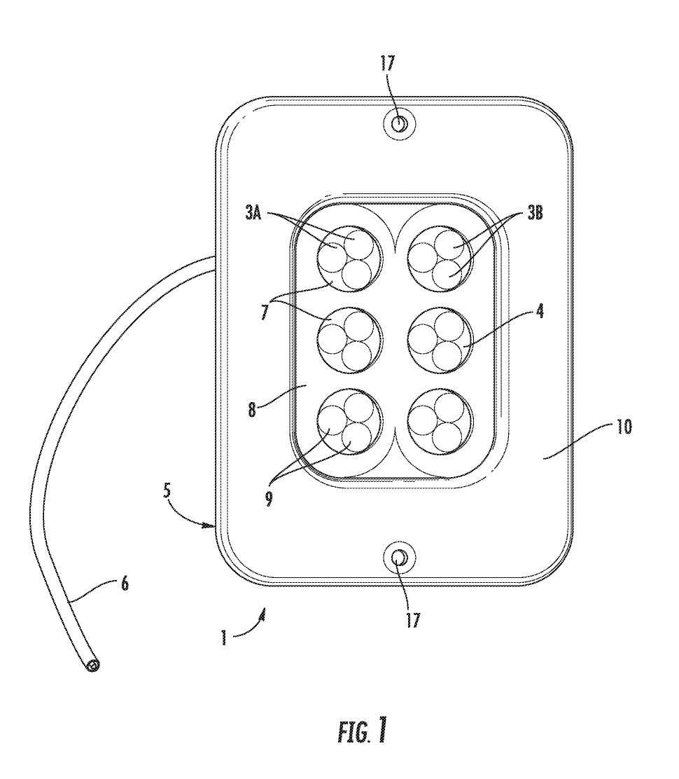

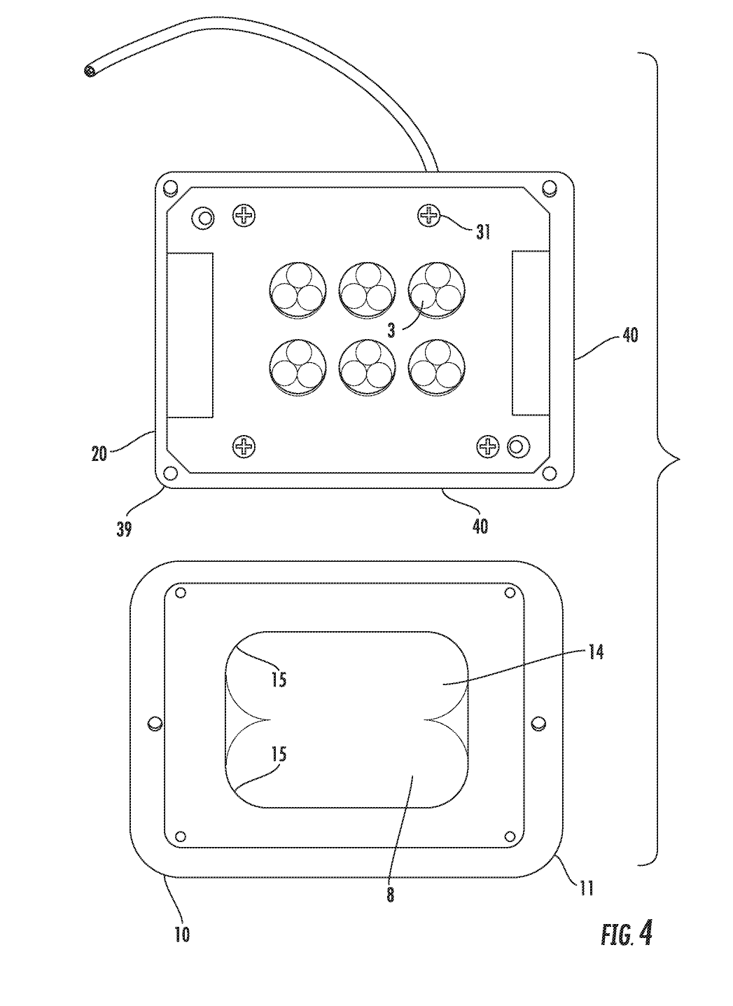

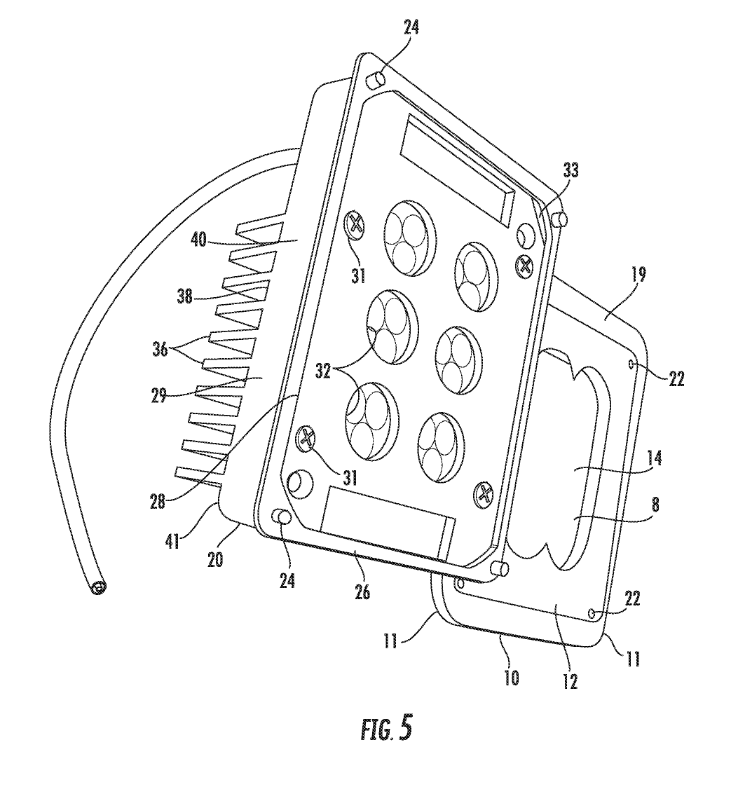

As best seen in FIGS. 4, 5, the mounting plate 10 is generally planar and rectangular, and has rounded corners 11. The window 8 is mounted on the mounting plate 10 as with any suitable adhesive that also forms a seal against water migration. The window 8 is in close relation to a viewing port 14. The port 14 and transparent window 8 allow light from the lights 3 to be emitted from the device 1. The port 14 is generally rectangular in shape and has rounded corners 15. In a preferred embodiment, the window 8 is positioned on the inside surface 12 of the plate 10. Also, the plate 10 can be generally planar. As shown, the plate 10 has a pair of countersunk through bores 17 (FIG. 1) to facilitate removable mounting of the device 1 to a transportation device such as a boat (not shown) with suitable screw fasteners (not shown). Additionally, the inside surface 12 of the plate 10 can be provided with a seal member 19 suitably secured thereto to provide sealing engagement with a panel of the transportation device. The plate 10 is suitably mounted to a receptacle 20 portion of the housing 5. As seen, the mounting plate 10 has a plurality of counterbores 22 recessed in the inside surface 12 of the plate 10, each adapted to receive a respective pin 24 secured to the receptacle 20 extending outwardly therefrom. A preferred pin 24 is a press fit roll pin. A seal 26 is positioned between the back face of the plate 10 and the front face of the receptacle 20 to provide sealing engagement therebetween. In a preferred embodiment, the seal 26 can also be a low strength adhesive to releasably secure the receptacle 20 and plate 10 together. It should be noted that while the plate 10 is illustrated as being rectangular, the construction of the light assembly allows the outer shape of the plate to take any desired shape, particularly about the perimeter, for covering apertures in a vessel or vehicle. This construction is advantageous over any known prior art, and allows the light to be adapted to pre-existing as well as new construction vessel or vehicle designs. For example, the outer perimeter of the plate 10 could be shaped as an oval, polygon, circle, or any other desirable shape which could also include logos, trademarks, trade-names or the like. This construction also allows the port 14 and window 8 to have any desirable shape so long as the light is still allowed to pass through the window. Still yet, the plate 10 could be shaped to allow multiple ports in a single plate for attachment of multiple light assemblies.

As described above, means is provided to facilitate mounting of the illumination device 1 to a transportation device (not shown). As shown, one means includes the countersunk through bores, or apertures, 17 in the plate 10 adapted to receive threaded fasteners 31 therethrough to fasten to the transportation device. These fasteners can also releasably secure the plate 10 to the receptacle 20. Because the face plate 10 can be of any shape, the light can be adapted to fit various styles and functions while still maintaining a sealed light.

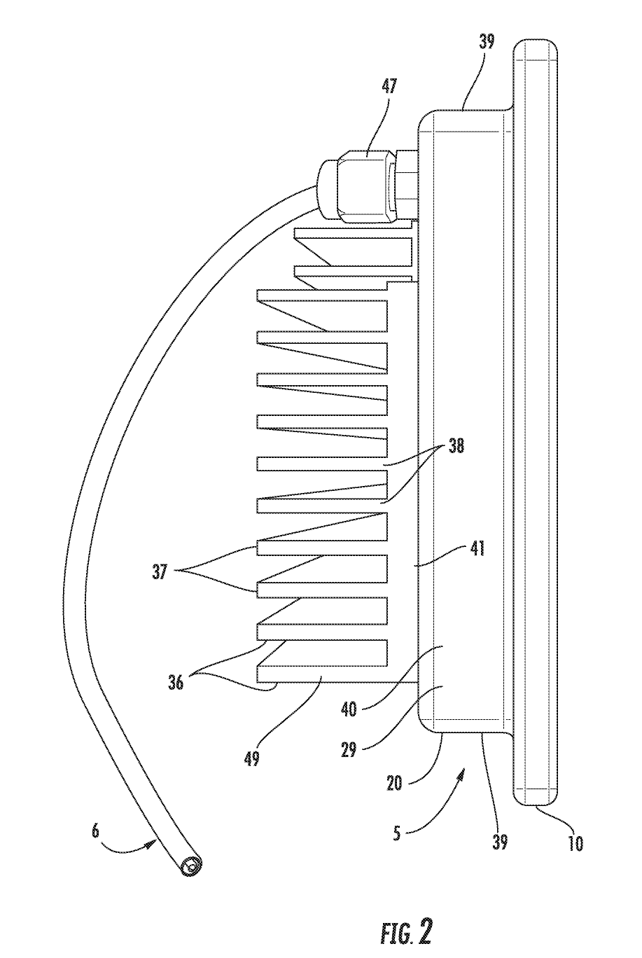

The receptacle 20 is best seen in FIGS. 2, 5. As seen in FIG. 5, the receptacle 20 includes a hatch plate 28 suitably secured to a base 29 of the housing 5, as with threaded fasteners 31. In the illustrated embodiment, the lights 3 and windows 7 fit within apertures 32 through the hatch plate 28. Preferably, the hatch plate 28 is generally planar and generally rectangular in shape having diagonal corners 33. The hatch plate 28 fits inside the base 29 having suitable thickness and heat transfer abilities to function as a secondary heat sink to the LEDs. In this manner, the present light may be placed in tight closed areas of a boat to allow heat to be transferred outside of the closed area through the front of the light as well as the rear and sides. This arrangement is very beneficial to LED light arrangements and adds significant longevity to the life of the LEDs.

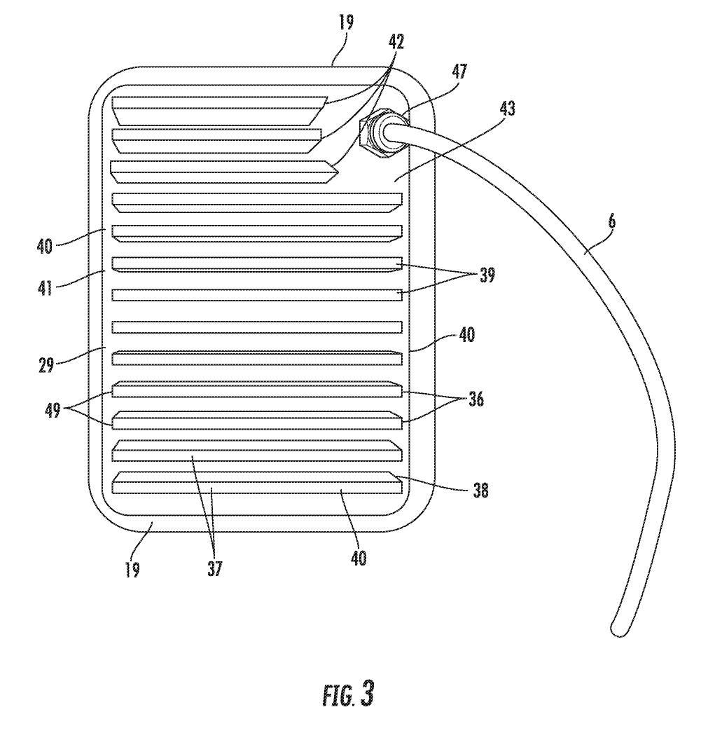

As seen in FIGS. 2, 3, the base 29 includes a plurality of spaced apart fins 36 projecting outwardly therefrom. The fins 36 project from the backside of the back panel 38 of the base 29, each having an outer end edge 37 with the end edges 37 lying generally in a plane. The fins 36 are in generally parallel relationship and are generally perpendicular to the backside of be back panel 38. Also, the fins 36 are generally planar and generally rectangular. The base 29 has a plurality of sidewalls 40 forming a generally rectangular array of walls, and has rounded corners 39 between the ends of the sidewalls 40. Edges of the sidewalls 40 transition to the backside 38 with rounded corners 41. As used in this application, the word “generally” means within manufacturing guidelines for products of this type.

As best seen in FIG. 3, the fins 36 adjacent the electrical source 6 are abbreviated in length with the ends 42 forming a portion of an arc, providing a generally planar surface 43 to facilitate mounting of the electrical source 6. The electrical source 6 in the illustrated structure is a conductive cable having a plurality of wires mounted to the base 29 via a suitable connector 47. Preferably, the connector 47 is a screw type connector that provides sealing engagement with the electrical source 6. The corners between the ends 37 and the side edges 49 of the fins 36 are preferably rounded.

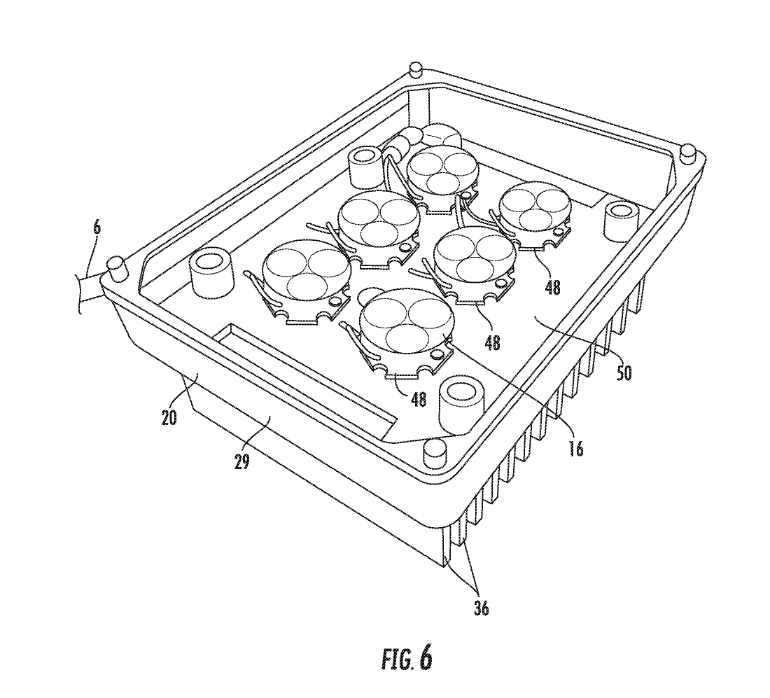

The electrical source 6 is adapted to be connected to a source of electricity, such as a battery carried by the transportation device. The lights 3 can be powered by direct current from the electrical source 6 as is known in the art. A high frequency current can also be used to power a light 3. Preferably, at least one suitable high frequency electronic device is housed inside the housing 5 and is electrically connected to a respective light 3 to suitably power the light 3. As shown in FIG. 6, each light 3 cluster 4 has its own high frequency electronic device. This can be provided by connecting a high frequency driver module 48, in the form of a circuit board, between the LED and the electrical source 6. In a preferred embodiment, each module 48 is mounted to a carrier 50, which is shown in the form of a plate. Preferably, the carrier 50 is of a good heat conductive material such as aluminum alloy, and is associated with a module 48 to provide for conductive heat transfer from a module and its respective light 3 cluster 4 to dissipate heat generated during operation of the lights 3. The carrier 50 is preferably in conductive heat transfer relationship with the base 29 and the fins 36.

The housing 5 and its component parts, including the receptacle 20 and mounting plate 10, are preferably made of a good heat conducting, corrosion resistant and durable material such as a metal alloy, and preferably an aluminum or stainless steel alloy. The parts can be made by casting. A preferred housing can be on the order of about 2 inches to about 8 inches in width and about 2 inches to about 12 inches in length. The height can be on the order of about 1 inch to about 5 inches. The fins 36 can be spaced apart about ⅛ inch to about ½ inch and have a height of greater than about ½ inch, and preferably in the range of between about ½ inch to about 3 inches. The fins 36 are preferably an integral part of the receptacle 20. The plate 10 and receptacle 20 can be coated with a suitable material, such as epoxy paint, to assist in resisting corrosion.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary, and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A modular illumination device comprising:
a housing, said housing having a back panel and a plurality of side panels integrally connected to each other to construct a base;
a plurality of light emitting diodes positioned within said base;
a hatch plate suitably secured to said base of housing so that a perimeter surface of said hatch plate contacts an inner surface of said side panels for heat transfer between said hatch plate and said base, said hatch plate secured in front of said plurality of light emitting diodes, said hatch plate including a plurality of apertures for allowing light from said light emitting diodes through said hatch plate;
a mounting plate having an inner surface and an outer surface, said mounting plate secured to said base so that said inner surface of said mounting plate rests against a top surface of said base, said mounting plate including a window positioned to be over said light emitting diodes, said mounting plate having a perimeter larger in diameter than said base, said mounting plate having a plurality of fastener apertures.

2. The modular illumination device of claim 1, wherein said mounting plate includes a bezel secured to said inner surface of said mounting plate.

3. The modular illumination device of claim 1, wherein said bezel is configured to collimate the light emitted from said light emitting diodes.

4. The modular illumination device of claim 3, wherein said bezel includes a Fresnel type configuration.

5. The modular illumination device of claim 1, including a sealing adhesive to prevent water migration between said mounting plate and said base.

6. The modular illumination device of claim 1, wherein said inner surface of said mounting plate includes a plurality of counterbores, said top surface of said base including a plurality of counterbores, a plurality of pins extending between said mounting plate counterbores and said base counterbores to align said mounting plate and said base.

7. The modular illumination device of claim 1, wherein said plurality of pins are roll pins.

8. The modular illumination device of claim 1, wherein said mounting plate includes a perimeter having a different shape than said base.

9. The modular illumination device of claim 1, wherein said base includes a plurality of spaced apart fins projecting outwardly therefrom, each having an outer end edge with the end edges lying generally in a plane.

10. The modular illumination device of claim 9, wherein said spaced apart fins are in generally parallel relationship and are generally perpendicular with respect to a backside of said base.

11. The modular illumination device of claim 9, wherein said plurality of light emitting diodes positioned within said base are positioned in groups behind said apertures in said hatch plate, each said light emitting diode including a lens, each said lens constructed and arranged to modify light emitted from said light emitting diodes.

12. The modular illumination device of claim 11, wherein said light emitting diodes are positioned in clusters of three.

13. The modular illumination device of claim 11 wherein said clusters of three light emitting diodes are positioned in rows within said base, said hatch plate having corresponding apertures to match said groups and rows of said light emitting diodes.

14. The modular illumination device of claim 13, wherein each said row includes a different type of lens and each row of said clusters is independently operable to cause light emitted from said diodes to be varied.

15. The modular illumination device of claim 1, including a mounting plate having two windows, said mounting plate secured to two bases.

16. The modular illumination device of claim 12, wherein each light emitting diode cluster has its own high frequency electronic device for operation of said light emitting diodes.
